(19) United States
(12) Patent Application Publication
(10) Pub. No.: US 2025/0125735 A1
(43) Pub. Date: Apr. 17, 2025

(54) DC-DC CONVERTER OF POWER CONVERSION SYSTEM

(71) Applicant: LS ELECTRIC CO., LTD., Anyang-si, Gyeonggi-do (KR)

(72) Inventors: Sun Ho BAE, Anyang-si, Gyeonggi-do (KR); Jae Ho LEE, Anyang-si, Gyeonggi-do (KR)

(21) Appl. No.: 18/726,032

(22) PCT Filed: Feb. 16, 2023
(86) PCT No.: PCT/KR2023/002281

§ 371 Date: Jul. 1, 2024

(30) Foreign Application Priority Data
Apr. 14, 2022 (KR) 10-2022-0046424

(51) Int. Cl. H02M 3/335; H02M 1/00

(52) U.S. Cl. CPC H02M 3/33584; H02M 1/0043

(57) ABSTRACT

A DC-DC converter according to an embodiment of the present disclosure comprises: a first stage converter for stepping up or stepping down an input voltage and outputting same; and a second stage converter connected to an output of the first stage converter. The first stage converter may comprise: first to fourth switches connected in series; fifth to eighth switches connected in series; a first capacitor connected in parallel with the series connection of the first and second switches; a second capacitor connected in parallel with the series connection of the third and fourth switches; a third capacitor connected in parallel with the series connection of the fifth and sixth switches; a fourth capacitor connected in parallel with the series connection of the seventh and eighth switches; a first inductor electrically connected to a first node between the first and second switches and a second node between the fifth and sixth switches; and a second inductor electrically connected to a third node between the third and fourth switches and a fourth node between the seventh and eighth switches.

### TECHNICAL FIELD

The present disclosure relates to a DC-DC converter of a power conversion system.

### BACKGROUND ART

A power conversion system converts direct current (DC) power into power suitable for application to other loads. For example, an electric vehicle may be equipped with a power conversion system that converts electrical energy stored in an energy storage device (battery) into power suitable for application to an electric motor.

The power conversion system may include a bidirectional DC-DC converter. The bidirectional DC-DC converter is capable of voltage conversion between an energy storage device and an inverter. The inverter may supply power to the electric motor, or may receive power from the electric motor through regenerative braking. In this case, the bidirectional DC-DC converter may adjust a voltage from the energy storage device to the inverter to supply power to the electric motor, or adjust a voltage from the inverter to charge the energy storage device.

Recently, the DC voltage used for solar power generation or energy storage devices has been increasing, and measures to protect systems, including energy storage devices, in the event of an accident are being required.

However, in the case of conventional DC-DC converters, an input and output voltage range is fixed to a narrow range. Therefore, in the case of conventional DC-DC converters, there are disadvantages such as increased loss, increased maximum current value, and occurrence of problems in a zero voltage switching range as fluctuations in input and output voltages increase. Accordingly, a bidirectional DC-DC converter with a wide input and output voltage range is required.

### DISCLOSURE OF INVENTION

### Technical Problem

The present disclosure provides a DC/DC converter capable of operating in a wide input and output voltage range.

The present disclosure provides a DC/DC converter capable of configuring a high voltage circuit using a low voltage switching element.

### Technical Solution

According to an embodiment of the present disclosure, a DC-DC converter includes a first stage converter configured to step up or step down an input voltage and output the stepped up or stepped down input voltage and a second stage converter connected to an output of the first stage converter, and the first stage converter may include first to fourth switches connected in series, fifth to eighth switches connected in series, a first capacitor connected in parallel to a series connection of the first and second switches, a second capacitor connected in parallel to a series connection of the third and fourth switches, a third capacitor connected in parallel to a series connection of the fifth and sixth switches, a fourth capacitor connected in parallel to a series connection of the seventh and eighth switches, a first inductor electrically connected to a first node between the first and second switches and a second node between the fifth and sixth switches, and a second inductor electrically connected to a third node between the third and fourth switches and a fourth node between the seventh and eighth switches.

The second stage converter may include a transformer, ninth to twelfth switches disposed on a primary side of the transformer, and thirteenth to sixteenth switches disposed on a secondary side of the transformer.

The second stage converter may include a first diode connected between the ninth switch and the tenth switch, and a second diode connected between the eleventh switch and the twelfth switch.

The second stage converter may be configured such that the ninth and tenth switches and the eleventh and twelfth switches operate in a complementary manner, the ninth switch is turned off before the tenth switch, and the twelfth switch is turned off before the eleventh switch.

The first inductor and the second inductor may be coupled to each other to form a coupled inductor.

The first stage converter may be configured such that a plurality of first converters each including the first to eighth switches, the first to fourth capacitors, and the first and second inductors are connected in parallel.

The second stage converter may be configured such that a plurality of second converters each including the transformer and the ninth to sixteenth switches are connected in parallel at inputs thereof and connected in series at outputs thereof.

### Advantageous Effects

According to the embodiments of the present disclosure, the DC-DC converter is composed of two stages, in which step-up and step-down of voltage are possible in the first stage, enabling operation over a wide input and output voltage range, and thus enabling operation with high efficiency despite fluctuations in the input and output voltages.

According to the embodiments of the present disclosure, configuration of a high-voltage circuit can be realized using low-voltage switching elements, thus reducing manufacturing costs.

According to the embodiments of the present disclosure, it is possible to reduce the ripple size through interleaved operation by configuring the first stage converter with N phases.

According to the embodiments of the present disclosure, the NPC circuit is applied to the second stage converter, thus simplifying the control logic.

### BRIEF DESCRIPTION OF DRAWINGS

FIG. 1 is a configuration diagram for describing an example of a power conversion system to which an embodiment of the present disclosure is applied.

FIG. 2 is a configuration diagram for describing another example of a power conversion system to which an embodiment of the present disclosure is applied.

FIG. 3 is a circuit diagram for describing a conventional DC-DC converter topology.

FIG. 4 is a diagram for describing a phase-shift control method for the DC-DC converter according to FIG. 3.

FIG. 5 is a circuit diagram for describing a DC-DC converter topology of an embodiment of the present disclosure.

FIG. 6 is a diagram for describing a control method for the DC-DC converter according to FIG. 5.

FIG. 7 is a circuit diagram for describing a DC-DC converter topology according to another embodiment of the present disclosure.

### BEST MODE FOR CARRYING OUT THE INVENTION

In order to fully understand the configuration and effects of the present disclosure, preferred embodiments of the present disclosure will be described with reference to the attached drawings. However, the present disclosure is not limited to the embodiments disclosed below, but can be implemented in various forms and various changes can be made. However, the description of the present embodiment is provided to ensure that the disclosure of the invention is complete and to fully inform those skilled in the art of the present disclosure of the scope of the invention. In the attached drawings, components are shown enlarged in size for convenience of description, and the proportions of each component may be exaggerated or reduced.

Although the terms “first”, “second”, etc. may be used to describe various components, the components should not be construed as being limited by the terms. The terms are only used to distinguish one component from another component. For example, a first component may be named as a second component, and vice versa, without departing from the spirit or scope of the present disclosure. As used herein, singular forms may include plural forms as well unless the context clearly indicates otherwise. Unless otherwise defined, terms used in the embodiments of the present disclosure may be interpreted as meanings commonly known to those skilled in the art.

Hereinafter, a DC-DC converter for a power conversion system of an embodiment of the present disclosure will be described with reference to the drawings.

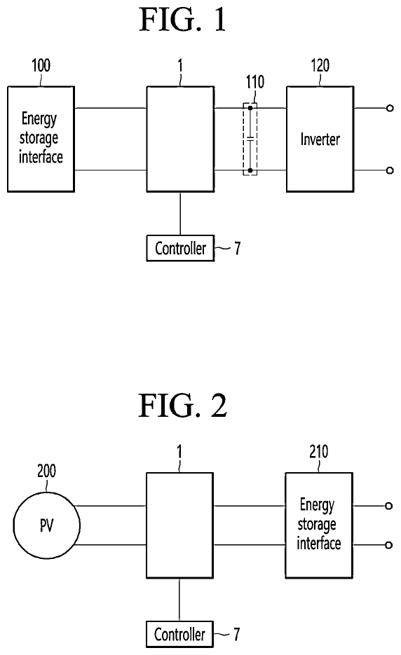

FIG. 1 is a configuration diagram for describing an example of a power conversion system to which an embodiment of the present disclosure is applied.

As shown in FIG. 1, the power conversion system to which an embodiment of the present disclosure is applied may include an energy storage interface 100, a DC-DC converter 1, a controller 7, a DC link interface 110, and an inverter 120.

In the system of FIG. 1, DC voltage stored in the energy storage interface 100 may be stepped up or stepped down by the DC-DC converter 1 of an embodiment of the present disclosure and transferred to the DC link interface 110, and DC voltage stored in the DC link interface 110 may be converted to alternating current (AC) voltage by the inverter 120 and transferred to the load.

As described above, the DC-DC converter 1 of an embodiment of the present disclosure may convert the magnitude of the DC voltage stored in the energy storage interface 100 and provide the DC voltage to the DC link interface 110.

In this case, the controller 7 may control a plurality of switches of the DC-DC converter 1 individually to perform conversion of an input DC voltage and output a DC voltage.

FIG. 2 is a configuration diagram for describing another example of a power conversion system to which an embodiment of the present disclosure is applied.

As shown in FIG. 2, a system to which an embodiment of the present disclosure is applied may include a photovoltaic (PV) 200, a DC-DC converter 1, a controller 7, and an energy storage interface 210.

In an embodiment of the present disclosure, the DC-DC converter 1 may convert a DC voltage produced by the PV 200 and provide the DC voltage for the energy storage interface 210 to store.

In this case, the controller 7 may control a plurality of switches of the DC-DC converter 10 individually to perform conversion of an input DC voltage and output a DC voltage.

It should be noted that the DC-DC converter 1 of the present disclosure may be applied to various systems that convert the magnitude of DC voltage and provide the DC voltage, without being restrictively provided to the above-mentioned system.

Hereinafter, a conventional DC-DC converter topology will be described, and then a DC-DC converter of an embodiment of the present disclosure will be described.

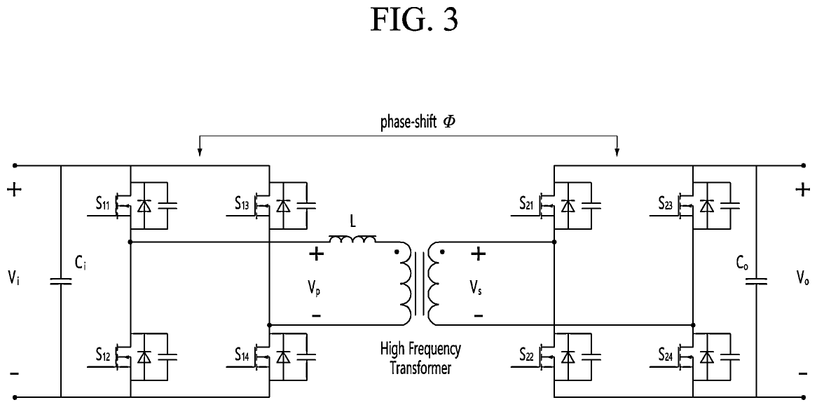

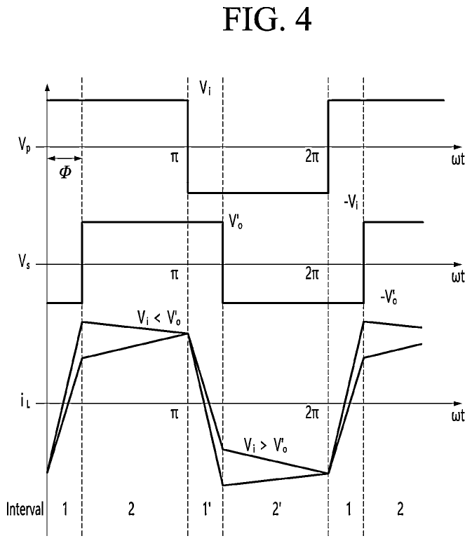

FIG. 3 is a circuit diagram for describing a conventional DC-DC converter topology, and FIG. 4 is a diagram for describing a phase-shift control method for the DC-DC converter according to FIG. 3.

As shown in FIG. 3, the conventional DC-DC converter uses a high frequency transformer and converts the magnitude of a DC voltage using phase-shift of the primary and secondary switches.

Since the conventional DC-DC converter transmits power by shifting the primary voltage (Vp) and secondary voltage (Vs), the direction of a current (iL) changes during an interval in which the phase of the primary voltage (Vp) is different from the phase of the secondary voltage (Vs). However, in an interval in which the direction of the current (iL) changes, the secondary voltage (Vs) has a positive sign and the current (iL) has a negative sign, or, conversely, the secondary voltage (Vs) has a negative sign and the current (iL) has a positive sign, so that a reactive current is generated and efficiency is reduced.

Additionally, there is a disadvantage that the reactive current increases as the input voltage (Vi) and output voltage (Vo') do not operate at predetermined optimal values.

In summary, a conventional DC-DC converter are designed to operate in a fixed range of input and output voltages, so when there is a change in the input or output voltage, efficiency decreases and losses increase.

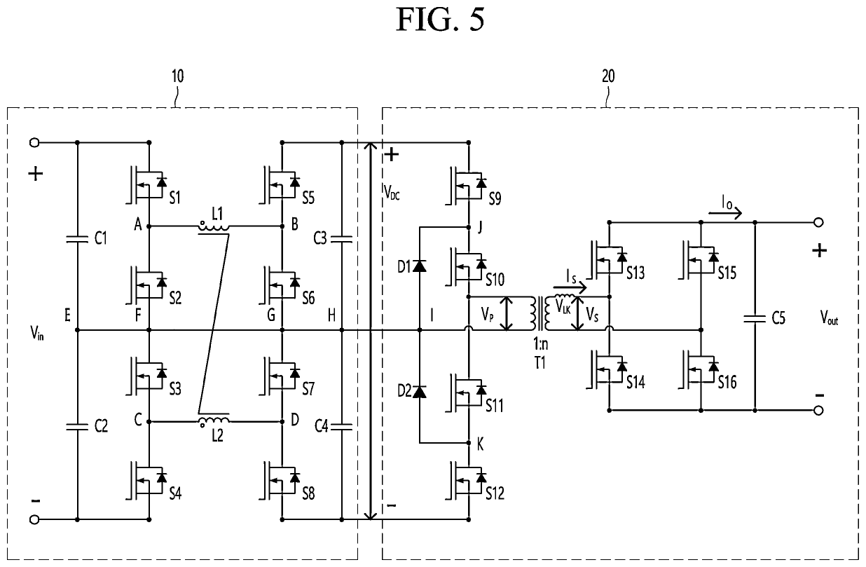

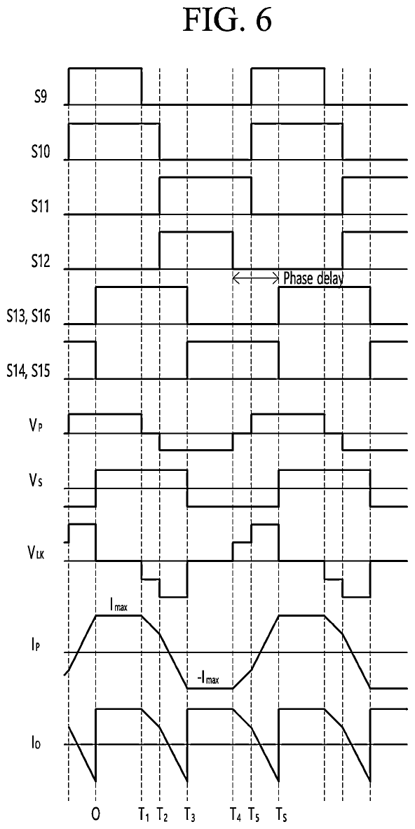

FIG. 5 is a circuit diagram for describing a DC-DC converter topology of an embodiment of the present disclosure, and FIG. 6 is a diagram for describing a control method for the DC-DC converter according to FIG. 5.

As described above, the conventional DC-DC converter has the disadvantage of having a narrow input/output voltage range, so the present disclosure seeks to configure two stages by connecting two converters. Accordingly, the DC-DC converter according to an embodiment of the present disclosure may be composed of a first stage converter and a second stage converter. The first stage converter may be the first converter 10 shown in FIG. 5, and the second stage converter may be the second converter 20 shown in FIG. 5.

That is, the DC-DC converter according to an embodiment of the present disclosure may be configured by combining the first converter 10 and the second converter 20.

The first stage converter may step up or step down the input voltage and output the stepped up or stepped down input voltage. The first converter 10 may include first to fourth switches S1, S2, S3, and S4 sequentially connected in series, and fifth to eighth switches S5, S6, S7, and S8 sequentially connected in series.

Meanwhile, the first to eighth switches S1, S2, S3, S4, S5, S6, S7, and S8 and the ninth to fifteenth switches S9, S10, S11, S12, S13, S14, S15, and S16 shown in FIG. 5 may each be, for example, a MOSFET (Metal Oxide Semiconductor Field Effect Transistor or an insulated gate bipolar transistor (IGBT), but the present disclosure is not limited thereto, and various types of semiconductor switching devices may be used.

The first switch S1 and the second switch S2 may operate in a complementary manner under the control of the controller 7. Operating in a complementary manner means that when the first switch S1 is turned on, the second switch S2 is turned off, and when the first switch S1 is turned off, the second switch S2 is turned on. Likewise, the third switch S3 and the fourth switch S4 may operate in a complementary manner, and the fifth switch S5 and the sixth switch S6 may operate in a complementary manner. Additionally, the seventh switch S7 and the eighth switch S8 may operate in a complementary manner.

The series connection of the first to fourth switches S1, S2, S3, and S4 and the series connection of the first capacitor C1 and the second capacitor C2 may be connected in parallel. In this case, the node F between the second switch S2 and the third switch S3 and the node E between the first capacitor C1 and the second capacitor C2 may be electrically equivalent. That is, the series connection of the first and second switches S1 and S2 may be connected in parallel to the first capacitor C1, and the series connection of the third and fourth switches S3 and S4 may be connected in parallel to the second capacitor C2.

Additionally, the series connection of the fifth to eighth switches S5, S6, S7, and S8 may be connected in parallel to the series connection of the third capacitor C3 and the fourth capacitor C4. In this case, the node G between the sixth switch S6 and the seventh switch S7 and the node H between the third capacitor C3 and the fourth capacitor C4 may be electrically equivalent. That is, the series connection of the fifth and sixth switches S5 and S6 may be connected in parallel to the third capacitor C3, and the series connection of the seventh and eighth switches S7 and S8 may be connected in parallel to the fourth capacitor C4.

The first inductor L1 may be electrically connected to node A between the first switch S1 and the second switch S2 and node B between the fifth switch S5 and the sixth switch S6. In addition, the second inductor L2 may be electrically connected to node C between the third switch S3 and the fourth switch S4 and node D between the seventh switch S7 and the eighth switch S8.

The first and second inductors L1 and L2 may be coupled to each other to form a coupled inductor. That is, the turns ratios of the first and second inductors L1 and L2 may be identical, and the primary coil of the first inductor L1 and the secondary coil of the second inductor L2 may be magnetically connected through a core. Since the coupled inductor consists of primary and secondary coils of the same turns ratio magnetically coupled through a core, there is an advantage in that the inductor size is reduced and losses are reduced.

In addition, in an embodiment of the present disclosure, the node F between the second switch S2 and the third switch S3 and the node G between the sixth switch S6 and the seventh switch S7 may be electrically equivalent. Therefore, the node E, the node F, the node G, and the node H may be electrically equivalent.

Due to the topology configured as described, the first converter 10 has a structure capable of stepping up and stepping down voltage in both directions.

Since the first converter 10 of one embodiment of the present disclosure is composed of four switches connected in series, it is possible to use a high input and output voltage based on a low voltage switching element. Additionally, the coupled inductor may reduce the volume of the inductor and reduce losses. Additionally, it is possible to efficiently respond to DC short circuit accidents.

The first converter 10 may perform control with VDC/2=VC3=VC4=Vout/n.

In the topology shown in FIG. 5, when the first converter 10 operates as a buck converter, the first and fourth switches S1, S2, S3, and S4 may be controlled to be turned on or off by the control of the controller 7, the second switch S2 may operate to be complementary to the first switch S1, and the third switch S3 may operate to be complementary to the fourth switch S4. Additionally, the fifth switch S5 and the eighth switch S8 may be controlled to be turned on, and the sixth switch S6 and the seventh switch S7 may be controlled to be turned off by the controller 7.

In addition, when the first converter 10 operates as a boost converter, the sixth and seventh switches S6 and S7 may be controlled to be turned on or off by the control of the controller 7, the fifth switch S5 may operate to be complementary to the sixth switch S6, and the eighth switch S8 may operate to be complementary to the seventh switch S7. Additionally, the first switch S1 and the fourth switch S4 may be controlled to be turned on, and the second switch S2 and the third switch S3 may be controlled to be turned off by the controller 7.

The second stage converter may include a transformer T1, ninth to twelfth switches S9 to S12 disposed on the primary side of the transformer, and thirteenth to sixteenth switches S13 to S16 disposed on the secondary side of the transformer.

The second converter 20 may be a DAB converter (Dual active bridge converter) to which NPC (Neutral Point Clamped) is applied. The second converter 20 may be a 3-level converter applying an NPC circuit to the primary side. In particular, the second converter 20 may be configured with one row of primary NPC circuits.

The second converter 20 may include ninth to twelfth switches S9, S10, S11, and S12, thirteenth to sixteenth switches S13, S14, S15, and S16, first and second diodes D1 and D2, a fifth capacitor C5, and a transformer T1.

An NPC circuit may be formed on the primary side, and a full bridge circuit may be formed on the secondary side.

The ninth to twelfth switches S9, S10, S11, and S12 are disposed on the primary side. The ninth and tenth switches S9 and S10 are connected in series, and the eleventh and twelfth switches S11 and S12 are connected in series. is connected in series. The first diode D1 is connected between the ninth switch S9 and the tenth switch S10, and the second diode D2 is connected between the eleventh switch S11 and the twelfth switch S12.

The ninth and tenth switches S9 and S10 and the eleventh and twelfth switches S11 and S12 may operate in a complementary manner. That is, when at least one of the ninth and tenth switches S9 and S10 is turned on, the eleventh and twelfth switches S11 and S12 may be turned off, and when at least one of the eleventh and twelfth switches S11 and S12 is turned on, the ninth and tenth switches S9 and S10 may be turned off.

Also, either of the ninth and tenth switches S9 and S10 may be in the on state for a longer period of time than the other. Likewise, either of the eleventh and twelfth switches may be in the on state for a longer period of time than the other. For example, the ninth switch S9 may be turned off before the tenth switch S10, and the twelfth switch S12 may be turned off before the eleventh switch S11. Through this, 3-level voltage may be output.

As current flows through the first and second diodes D1 and D2, voltage levels may be divided into three, which can be seen through the waveform of Vp in FIG. 6.

Since VLK=nVp−Vs in the second converter 20, when nVp=Vs in the interval of 0 to T1, VLK=0 is achieved and there is no change in the magnitude of current. In the interval of T1 to T2, the ninth switch S9 is turned off before both the ninth switch S9 and the tenth switch S10 are turned off, and therefore, the first diode D1 conducts, resulting in VS9=VC3. At time T3, the tenth switch S10 is turned off, resulting in VS10=VC4 and as a result, VS9=VS10. The interval of T2 to T3 is an interval in which phase shift is achieved, and current control is possible by adjusting the interval.

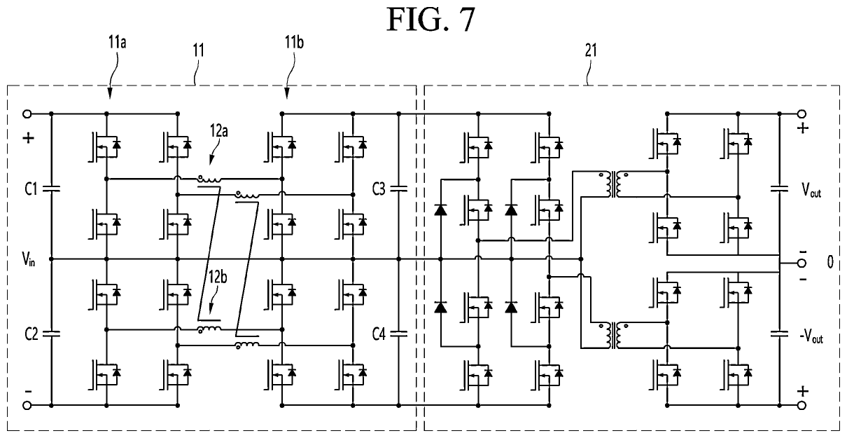

FIG. 7 is a circuit diagram for describing a DC-DC converter topology according to another embodiment of the present disclosure.

The DC-DC converter 1 according to another embodiment of the present disclosure is also composed of two stages, which are a combination of a first stage converter and a second stage converter, similar to that described in FIG. 5, but the first stage converter is a third converter 11, and the second stage converter may be the fourth converter 21.

The third converter 11 may be a converter in which the first converter 10 described in FIG. 5 is implemented with N- phase, and the fourth converter 21 may be a converter in which the second converters 20 described in FIG. 5 are connected in series.

First, the third converter 11 is described. The third converter 11 is composed of the first converter 10 with N phases, and may have a structure in which a plurality of first converters 10 are connected in parallel.

Specifically, for each phase in the third converter 11, in two legs 11a and 11b including four switches connected in series, a first inductor 12a is connected at each of nodes between two upper switches, and a second inductor 12b is connected at each of nodes between two lower switches. The first and second inductors 12a and 12b may be coupled inductors with the same number of turns.

The series connection of the two upper switches of the first leg 11a may be connected in parallel to a first capacitor C1, and the series connection of the two lower switches may be connected in parallel to a second capacitor C2. Additionally, the series connection of the two upper switches of the second leg 11b may be connected in parallel to a third capacitor C3, and the series connection of the two lower switches may be connected in parallel to a fourth capacitor C4.

The configuration of one phase has been described above, which is the same as that described in FIG. 5, and the configuration is the same for the remaining phases. In FIG. 7, the third converter 11 is assumed to be implemented with two phases, but this is only an example for convenience of description, and the third converter 11 may be implemented with N phases. As described above, when the third converter 11 is implemented with N phases, interleaved operation is possible through a plurality of inductors, which has the advantage of reducing the size of the ripple.

In the fourth converter 21, a plurality of the second converters 20 described in FIG. 5 are connected. In this case, the inputs of the plurality of the second converters may be connected in parallel and the outputs may be connected in series. Accordingly, the output of the fourth converter 21 may be a series connection of the outputs of the plurality of second converters 20.

In addition, the fourth converter 21 is configured such that the outputs of DAB converters to which NPC is applied are connected in series, thus enabling an bipolar output.

As such, the DC-DC converter 1 according to various embodiments of the present disclosure may be configured as an isolated type, and the first converter 10 and the third converter 11 are capable of step-up and step-down in both directions, thus being able to operate over a wide input and output voltage range. Therefore, the DC-DC converter 1 according to various embodiments of the present disclosure has the advantage of operating with high operating efficiency regardless of specific voltage conditions. In addition, the DC-DC converter 1 according to various embodiments of the present disclosure has the advantage that the second converter 20 and the fourth converter 21 can be driven at 3 levels, allowing a high-voltage circuit to be configured with a low-voltage switching element.

The above description is merely illustrative of the technical idea of the present disclosure, and various modifications and variations may be made without departing from the essential characteristics of the present disclosure by those skilled in the art to which the present disclosure pertains.

Accordingly, the embodiment disclosed in the present disclosure is not intended to limit the technical idea of the present disclosure but to describe the present disclosure, and the scope of the technical idea of the present disclosure is not limited by the embodiment.

The scope of protection of the present disclosure should be interpreted by the following claims, and all technical ideas within the scope equivalent thereto should be construed as being included in the scope of the present disclosure.

1. A DC-DC converter comprising:
a first stage converter configured to step up or step down an input voltage and output the stepped up or stepped down input voltage; and
a second stage converter connected to an output of the first stage converter,
wherein the first stage converter includes
first to fourth switches connected in series;
fifth to eighth switches connected in series;
a first capacitor connected in parallel to a series connection of the first and second switches;
a second capacitor connected in parallel to a series connection of the third and fourth switches;
a third capacitor connected in parallel to a series connection of the fifth and sixth switches;
a fourth capacitor connected in parallel to a series connection of the seventh and eighth switches;
a first inductor electrically connected to a first node between the first and second switches and a second node between the fifth and sixth switches; and
a second inductor electrically connected to a third node between the third and fourth switches and a fourth node between the seventh and eighth switches.

2. The DC-DC converter of claim 1, wherein the second stage converter includes:
a transformer;
ninth to twelfth switches disposed on a primary side of the transformer; and
thirteenth to sixteenth switches disposed on a secondary side of the transformer.

3. The DC-DC converter of claim 2, wherein the second stage converter includes:
a first diode connected between the ninth switch and the tenth switch; and
a second diode connected between the eleventh switch and the twelfth switch.

4. The DC-DC converter of claim 3, wherein the second stage converter is configured such that:
the ninth and tenth switches and the eleventh and twelfth switches operate in a complementary manner;
the ninth switch is turned off before the tenth switch; and
the twelfth switch is turned off before the eleventh switch.

5. The DC-DC converter of claim 1, wherein the first inductor and the second inductor are coupled to each other to form a coupled inductor.

6. The DC-DC converter of claim 1, wherein the first stage converter is configured such that a plurality of first converters each including the first to eighth switches, the first to fourth capacitors, and the first and second inductors are connected in parallel.

7. The DC-DC converter of claim 6, wherein the second stage converter is configured such that a plurality of second converters each including the transformer and the ninth to sixteenth switches are connected in parallel at inputs thereof and connected in series at outputs thereof.
